(19) United States
(12) Patent Application Publication
(10) Pub. No.: US 2023/0044461 A1
(43) Pub. Date: Feb. 9, 2023

(54) Fully Collateralized Stablecoins that Pay a Fixed Rate of Interest

(71) Applicant: Philip Scott Lyren, Bangkok (TH)

(72) Inventor: Philip Scott Lyren, Bangkok (TH)

(21) Appl. No.: 17/394,376

(22) Filed: Aug. 4, 2021

(51) Int. Cl. G06Q 40/02; G06Q 40/04; G06Q 20/38

(52) U.S. Cl. CPC G06Q 40/02; G06Q 20/381; G06Q 20/382; G06Q 40/04; G06Q 2220/00

(57) ABSTRACT

Methods and apparatus provide improved stablecoins on a blockchain. The stablecoins are collateralized to fiat-based stablecoins that are loaned to borrowers from a lending pool. Loan payments received from the borrowers are divided into a first portion that buys fiat currency that over-collateralizes the stablecoins and a second portion that pays owners of the stablecoins a fixed rate of interest that does not vary over time.

### BACKGROUND

Stablecoins are blockchain-based cryptocurrencies in which the price is tied to a cryptocurrency, fiat money, or a commodity, such as gold. These coins were invented to provide a cryptocurrency that is stable, safe, and easily transferable for financial transactions throughout the world. In practice, however, various technical challenges exist in designing a stablecoin with these attributes.

Example embodiments offer solutions to some of these technical challenges and assist in providing technological advancements in methods and apparatus for stablecoins on a blockchain.

### BRIEF DESCRIPTION OF THE DRAWINGS

FIG. 1 shows the layout of the decentralized finance (DeFi) borrow and lending system executing a protocol in accordance with an example embodiment.

FIG. 2 shows an example electronic device with a user interface or dashboard that enables a user to borrow USDC from the borrowing and lending protocol in accordance with an example embodiment.

FIG. 3 shows an example electronic device with a user interface or dashboard that enables a user to borrow USDC from the borrowing and lending protocol in accordance with an example embodiment.

FIG. 4 shows a method to generate additional stablecoins when the stablecoins become over-collateralized in accordance with an example embodiment.

FIG. 5 is a method that determines when to generate or burn stablecoins for the lending pool in accordance with an example embodiment.

FIG. 6 shows an electronic device with a display that shows information posted at the URL of the Bob protocol in accordance with an example embodiment.

FIG. 7 is an electronic device in accordance with an example embodiment.

FIG. 8 is an electronic or computer system in accordance with an example embodiment.

FIG. 9 is a method that provides improved stablecoins that are fully collateralized and pay a fixed rate of interest to owners of the stablecoins in accordance with an example embodiment.

### SUMMARY

Example embodiments include methods and apparatus that provide stablecoins on a blockchain. The stablecoins are fully collateralized and pay a fixed rate of interest to owners of the stablecoins.

Other example embodiments are discussed herein.

### DETAILED DESCRIPTION

One or more example embodiments in accordance with the invention include a stablecoin and a protocol that governs the stablecoin. For illustration, the stablecoin is referred to as the “Bob coin” and the protocol is referred to as the “Bob protocol.” The name “Bob” in the terms Bob coin and Bob protocol is provided as a generic name that should not be read to limit example embodiments. Instead, the name “Bob” is provided to assist the reader in identifying the stablecoin and protocol of one or more example embodiments.

The Bob coin is a new type of cryptocurrency stablecoin that pays a fixed rate of interest to holders of the stablecoin. During the initial coin launch or coin generation, each Bob coin is sold or swapped for a single US dollar (or other fiat currency or commodity) or a single stablecoin, such as a United States dollar coin (USDC), USD tether (USDT), or another stablecoin that pegs the price of each Bob coin to one USD or another currency. For illustration, example embodiments discuss USDC, though a person of ordinary skill in the art will appreciate that other stablecoins and other fiat currencies or commodities can be utilized, such as a stablecoin issued by the US government, European Central Bank, Chinese government, or another country.

The USDC generated from the coin launch form a lending pool from which the USDC are loaned to borrowers for a fixed rate of interest. An autonomous and decentralized protocol (called the Bob protocol) governs the lending and borrowing of the USDC via smart contracts, such as smart contracts executing on the Ethereum blockchain or another blockchain.

To receive USDC from the lending pool, borrowers provide a cryptocurrency (or a commodity such as gold) as collateral and receive back this cryptocurrency upon returning the borrowed USDC and a fixed rate of interest payment. The USDC returns to the lending pool for loans to other borrowers, and the fixed rate of interest payments are split. A portion of the interest payment is paid to the holders of the Bob coin as a fixed rate of interest payment, and a portion of the interest payment purchases USD reserves and/or additional USDC for the lending pool.

Overtime, the Bob coins transition from being fully collateralized at the coin launch to being over-collateralized from the additional purchase of USDC and/or USD reserves. Over-collateralization triggers the Bob protocol to generate and sell a small number of new Bob coins while continuing to maintain full collateralization of each Bob coin to one USD and/or USDC. While holding the Bob coin, owners of the coin continue to receive payment of a fixed rate of interest, such as a fixed annual percentage yield (APY) or a fixed annual percentage rate (APR). Transactions, including collateralization of the coin, are readily viewable and verifiable by the public at any time as these transactions are on a public blockchain.

In addition to many benefits, decentralized financing on the blockchain has brought corruption, graft, scams, and greed, which mirror problems endemic to centralized financing. One purpose of the Bob coin is to provide a corrupt-free stablecoin pegged to the US dollar that can compete with centralized banking products that provide income at low-risk, such as certificate of deposits (CDs), treasuries, and high-yield savings accounts. One purpose of the Bob protocol is to provide an autonomous, decentralized, trusted, and secure framework for the Bob coin so it can legitimately compete with centralized banks. The Bob coin and its protocol fulfills these purposes and provide people with a trusted and secure stablecoin that provides holders of the coin with payment of a fixed interest rate or fixed rate of return.

The Bob coin is designed for people who are interested in gaining exposure to cryptocurrency but are worried about volatility and security. Each Bob coin is backed by at least one USD or USDC. Cryptocurrency investors and traders will use the Bob coin as a secure way to store cryptocurrency assets while earning a fixed rate of interest. Owners of other cryptocurrencies will use the Bob protocol to borrow USDC with a fixed, low rate of interest. In this way, borrowers can get easy, low-cost access to US dollars without having to sell their cryptocurrency. Further, the Bob coin, as a stable digital currency, can be used to make payments and transfers of money around the world in a secure, easy, fast, and inexpensive way that can compete with centralized banking financial services.

As discussed herein, the Bob coin and the Bob protocol provide significant improvements and technological advancements over traditional stablecoins and conventional decentralized finance (DeFi) borrowing and lending protocols.

The most popular stablecoins on the market are cryptocurrency-backed coins and fiat-backed coins. These stablecoins have problems.

Crypto-backed coins, such as DAI, are problematic because their value is tied to the price of a cryptocurrency, and this price can fluctuate wildly. Further, due to their reliance on supplementary instruments, high volatility, and non-direct backing, it is difficult to comprehend how the price is ensured.

Fiat-backed coins, such as USD Coin (USDC) and USD Tether (USDT), are more secure since they are based on fiat money, such the US dollar. USDT, however, was sued by the New York Attorney General for covering up hundreds of millions of dollars in missing funds and making false statements about being fully backed by the US dollar. Furthermore, USDC and USDT are not fully decentralized stablecoins because their USD reserves are kept in centralized financial institutes. Further yet, none of these stablecoins offer owners a financial incentive as an interest rate to hold the coins.

As discussed more fully below, the Bob coin cures these problems with a stablecoin that provides owners with a fixed rate of interest. Further, each Bob coin is fully backed by a USD coin and/or USD, and this collateralization is readily transparent on an open public ledger with a protocol governed by smart contracts.

The financial industry currently has a myriad of different decentralized finance (DeFi) protocols built on public blockchains that provide borrowing and lending of cryptocurrencies. Compound Finance (Compound) is an example of one such protocol that enables users to borrow and lend certain cryptocurrencies from each other. Compound supports borrowing and lending of several principal cryptocurrencies (coins) that include DAI, ETH, USDC, UNI, ZRX, USDT, WBTC, BAT, and REP. Users (suppliers) supply coins to the pool and earn interest, and other users (borrowers) borrow these coins from the pool and pay interest. The APY interest paid is an algorithmically derived floating interest rate based on the supply and demand of the particular coin the user deposits or borrows.

Compound and other DeFi institutes have problems inherent in their cryptocurrency lending protocols. Several problems stem from the APY being based on supply and demand.

First, on any given day, the APY can vary significantly between different coins. This difference occurs because like coins pool together and establish different money markets. The interest rate for each money market (or pools of coins) can vary greatly. For example, users depositing DAI on 12 Jun. 2021 at Compound received an APY of 2.56%, while users depositing ETH on the same day received an APY of 0.14%.

Second, the APY can vary widely over short periods of time for the same coin. For example, during a one-month window in March 2020, the APY for DAI varied from over 20% to under 3%.

Third, Compound does not immediately pay interest to lenders, but deposits cTokens into the lender’s account. When the lender closes the loan, the cTokens convert into the coin initially deposited. The value of these cTokens inevitably depends on the value of the underlying coin, which fluctuates.

Fourth, the Compound protocol and other protocols apply a different collateral ratio for each type of coin being deposited as collateral. Collateral ratio is the ratio of the value of coin being supplied to the value of coin being borrowed. These different collateral ratios complicate the borrowing and lending process and provide an inherent inequality between different cryptocurrencies.

These facts lead to an unstable and unpredictable lending and borrowing environment. It is impossible for lenders and borrowers to predict the interest rate and hence cannot accurately know in advance their rate of return (RoR).

The Bob coin and the Bob protocol cures these problems.

As discussed more fully herein, one or more example embodiments of the Bob coin and the Bob protocol provide advantages over conventional stablecoins and protocols that include one or more of the following:
(1) The Bob coin is a stablecoin tied to the USD in which every coin is fully collateralized from the initial coin launch and remains fully collateralized throughout its life to at least one USD or USDC.
(2) Collateralization of the Bob Coin is transparent and verifiable by the public as this information is posted or made available as part of the Bob protocol.
(3) Over time, Bob coins transition from being fully collateralized with USDC to being over-collateralized with USDC and/or USD.
(4) Holders of the Bob coin receive a fixed rate of interest that does not change over time.
(5) Holders of the Bob coin receive interest payments in USDC.
(6) Borrowers of USDC from the lending pool pay a fixed rate of interest regardless of the cryptocurrency being deposited as collateral.
(7) The Bob protocol applies the same collateral ratio to all borrowers regardless of the cryptocurrency being deposited as collateral.

For illustration, consider an example in which Bob coins launch on the Ethereum blockchain as an ERC-20 token governed through a series of smart contracts that define the Bob protocol (discussed herein). The initial coin launch (ICL) offers fifty million (50M) Bob coins with a set minimum purchase price of $1 US per Bob coin. Per code in the smart contract, a sale of a Bob coin during the initial coin launch cannot occur for any value less than one USDC. Each Bob coin can be purchased or swapped for one USDC which is added to the lending pool. At all points in time during the ICL and thereafter, each Bob coin is fully collateralized with one USDC. After the initial coin launch, the Bob coins become over-collateralized as income generated from USDC in the lending pool buys USD reserves and/or additional USDC.

In an example embodiment, one hundred percent (100%) of the USDC stablecoins generated from the ICL are allocated to the Bob protocol for immediate lending via the lending pool. This ensures that each Bob coin is immediately and fully backed by at least one USDC. At no time during the ICL or anytime thereafter does the number of circulating Bob coins exceed the number of USD and USDC providing collateral. This protocol is coded into the smart contracts to protect holders of the Bob coin and maintain its stability tied to the US dollar.

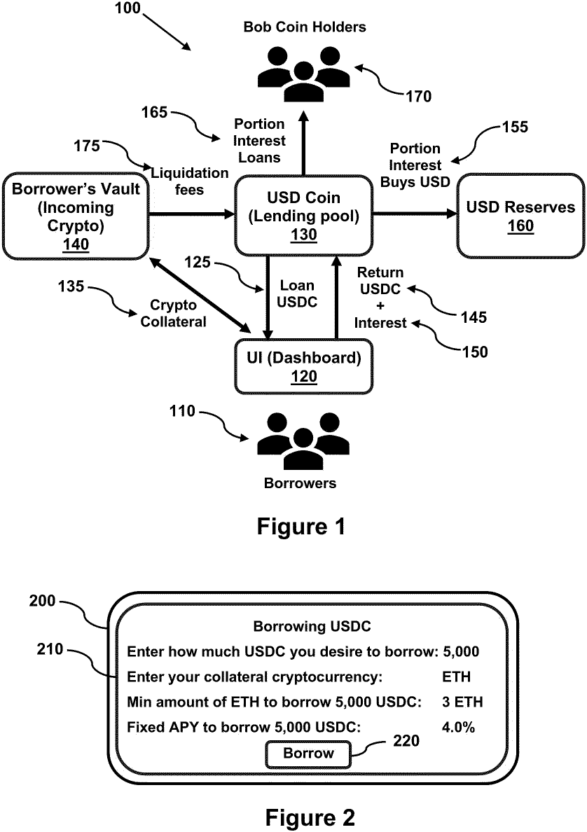

FIG. 1 shows the layout of the decentralized finance (DeFi) borrow and lending system 100 executing a protocol in accordance with an example embodiment.

As shown, borrowers 110 interact with a user interface (UI) or dashboard 120 to borrow USDC 125 from a USDC lending pool 130. Borrowers 110 provide a cryptocurrency 135 as collateral that is stored in a borrower’s vault 140. Borrowers return the borrowed USDC 145 to the lending pool 130 along with payment of a fixed rate of interest 150. A portion of this interest rate payment 155 purchases USD reserves 160 and/or additional USDC for the lending pool 130, and a portion of this interest rate payment 165 is paid to the Bob coin holders 170. Liquidation fees 175 collected from cryptocurrency collateral 135 from the borrowers 110 are also used to purchase additional USDC and/or USD reserves 160 for the lending pool 130.

The Bob protocol executes within the system 100 and allows borrowers 110 to borrow USDC with a variety of cryptocurrency assets 135 provided as collateral. Users or borrowers connect via a web3 wallet (such as Coinbase, Ledger, Metamask, etc.), and the Bob protocol provides a dashboard interface 120 to borrow USDC.

FIG. 2 shows an example electronic device 200 with a user interface or dashboard 210 that enables a user to borrow USDC from the borrowing and lending protocol in accordance with an example embodiment.

At the user interface 210, the user enters how much USDC they desire to borrow and identifies the underlying cryptocurrency to supply as collateral, such as ETH, BTC, etc. The dashboard then displays the minimum amount of cryptocurrency required to borrow the desired USDC. Alternatively, users can input an amount of cryptocurrency to find out how much USDC can be borrowed. The dashboard also displays the fixed rate of interest, terms of service, amount needed to avoid liquidation, and other useful information.

For illustration purposes, the user interface shows the user borrowing 5000 USDC with 3 ETH as collateral. The user will pay a fixed APY of four percent (4%).

When the user activates a borrow button 220, a cryptocurrency exchange occurs: The user transfers the underlying cryptocurrency to an address of the Bob protocol, and the Bob protocol deposits the USDC into the address of the web3 wallet of the user. The Bob Protocol holds the incoming cryptocurrency in a secure vault or storage as collateral for the loan. The incoming cryptocurrency is not converted into another cryptocurrency unless liquidation occurs. When the borrower returns the borrowed USDC along with payment of the fixed rate of interest, the Bob protocol returns the underlying cryptocurrency provided as collateral back to the borrower.

The Bob protocol executes a collateral ratio to limit the maximum amount of USDC that can be borrowed against an underlying cryptocurrency. The collateral ratio is defined as follows:

$$\frac{\left(\text{Market value} \left(\text{USDC}\right) \text{of cryptocurrency supplied as collateral}\right)}{\left(\text{Number of USDC being borrowed}\right) \text{.}}$$

When a user requests to borrow USDC, the Bob protocol contacts one or more decentralized exchanges (DEX), retrieves the real-time market price of the cryptocurrency being supplied as collateral, and calculates the market value of the cryptocurrency in USDC. The dashboard displays the real-time market price of the cryptocurrency, the maximum amount the user can borrow, and other useful information.

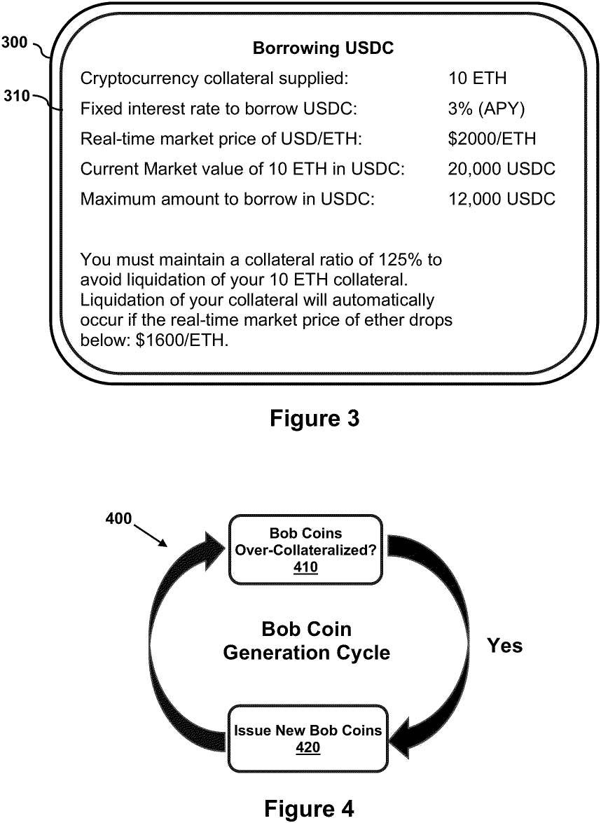

FIG. 3 shows an example electronic device 300 with a user interface or dashboard 310 that enables a user to borrow USDC from the borrowing and lending protocol in accordance with an example embodiment.

Consider an example in which a user owns 10 ETH and desires to borrow USD. The user could sell some of this ether for USD, but she believes the price of the ether will rise in the future and hence prefers not to sell. She navigates to the

Uniform Resource Locator (URL) of the Bob protocol, connects via her MetaMask wallet, and enters 10 ETH to see how much USDC she can borrow. The dashboard 310 displays the following information:

| | |
|---|---|
| Cryptocurrency collateral supplied: | 10 ETH |
| Fixed interest rate to borrow USDC: | 3% (APY) |
| Real-time market price of USD/ETH: | $2000/ETH |
| Current Market value of 10 ETH in USDC: | 20,000 USDC |
| Maximum amount to borrow in USDC: | 12,000 USDC |

You must maintain a collateral ratio of 125% to avoid liquidation of your 10 ETH collateral. Liquidation of your collateral will automatically occur if the real-time market price of ether drops below: $1600/ETH.

The maximum amount of USDC the user can borrow is approximately fifteen percent (15%) below the price at which liquidation occurs. This difference provides the user with a 15% cushion against a drop in price of the underlying security being deposited as collateral if the user elects to withdraw the maximum amount of USDC.

The Bob protocol provides the users with an option to receive a notification (email, text, etc.) if the price of the underlying collateral drops within five percent (5%) of the liquidation price. This notification is optional as users may desire to maintain privacy.

In an example embodiment, the Bob protocol applies the same collateral ratio to all borrowers regardless of the underlying cryptocurrency being provided as collateral. This protocol simplifies borrowing and applies the same principles of fairness to all borrowers regardless of the cryptocurrency being used as collateral.

In an example embodiment, regardless of the cryptocurrency offered as collateral, all borrowers pay a fixed interest rate coded into the smart contract. Unlike other borrowing and lending crypto protocols, this fact greatly simplifies the lending process and enables borrowers to easily calculate the interest owed. Further, the interest rate remains fixed throughout the duration of the loan regardless of the price movement of the underlying cryptocurrency being held as collateral. Here, the Bob protocol is vastly different than other protocols, such as conventional protocols in which interest rates vary relative to the amount of liquidity present in each market and fluctuate in real-time based on supply and demand.

Bob coin holders receive payment of a fixed interest rate that is paid in USDC. The Bob protocol calculates interest earned when a new block is added to the blockchain, such as the Ethereum blockchain or another blockchain that supports smart contracts. The dashboard shows a Bob coin holder the number of Bob coins owned, the fixed APY, and the real-time amount of compound interest earned.

After the initial coin launch, each Bob coin is tied to one USDC that is available for loan to a borrower via the lending pool. Interest paid by the borrower is paid to the Bob coin holder in USDC as a fixed rate of interest that does not vary over time.

In an example embodiment, this protocol works effectively as long as two conditions remain true: The number of Bob coins in circulation equals the number of USDC in the lending pool, and all USDC in the lending pool are always loaned out earning interest.

The first condition is coded into the smart contracts and remains true. In an example embodiment, all Bob coins in the initial coin launch, sale, or swap are sold for one USDC and are immediately provided to the lending pool. This ensures the number of Bob coins in circulation continually equals the number of USDC in the lending pool.

A potential problem exists. What happens when demand for borrowing USDC wanes and the lending pool has USDC that are not being loaned out to borrowers? This surplus of USDC in the lending pool is not earning interest and hence is unable to contribute to paying the Bob coin holders a fixed rate of interest.

The Bob protocol executes several mechanisms to address this problem and maintain payment of a fixed rate of interest to the Bob coin holders.

First, the fixed interest rate paid by the borrowers is greater than the fixed interest rate paid to the holders of the Bob coin. This fact enables the Bob protocol to pay a fixed interest rate even when all USDC in the lending pool are not dispersed for loan. Holders of the Bob coin will still receive payment of the fixed interest rate as long as the number of USDC in the lending pool loaned out is equal to or above a minimum amount (USDC_{MIN}).

USDC_{MIN} is the minimum number of USDC that need to be loaned out from the lending pool in order to generate sufficient interest income to pay Bob coin holders a fixed interest rate. If the number of USDC loaned out is less than USDC_{MIN} then the money generated from interest paid by borrowers of these USDC loaned out is not sufficient to pay the interest being paid to the holders of the Bob coin. If the number of USDC loaned out is equal to or greater than USDC_{MIN} then the money generated from interest paid by borrowers of these USDC loaned out is sufficient to pay the interest being paid to the holders of the Bob coin.

This minimum number of USDC (USDC_{MIN}) is provided as follows:

$${\text{USDC}}_{\text{MIN}} \text{=} \frac{\left(\text{Number of Bob Coins Issued}\right) \times \left(\text{Fixed Interest Rate Difference}\right)}{\left(\text{Fixed Interest Rate Paid by Borrowers}\right) \text{.}}$$

This equation is based on each Bob coin being fully collateralized with one USDC. The number of Bob coins issued is the number of coins in circulation or issued to receive a fixed interest rate payment. The fixed interest rate difference is the difference between the fixed interest rate paid by borrowers and the fixed interest rate paid to the holders of the Bob coin.

Second, over time, the total number of USDC in the lending pool increases as a portion of the interest rate paid by the borrowers is used to purchase additional USDC and/or USD reserves. Over time, the number of USDC in the lending pool will be greater than the total number of Bob coins. This over-collateralization of USDC provides additional interest income that assists in maintaining a fixed interest rate payment to holders of the Bob coin. This over-collateralization also provides additional USDC to the lending pool when demand for loans is high (e.g., when the demand for USDC from the lending pool is greater than the number of Bob coins in circulation).

A situation can occur when the demand to borrow USDC is so low that the income generated from interest paid by borrowers is not sufficient to pay the fixed interest rate to holders of the Bob coin. In this situation, any interest paid by the borrowers is paid to the holders of the Bob coin even though the amount being paid is less than the fixed interest rate.

An occurrence of this event would not be catastrophic since during this time each Bob coin would still be a fully collateralized stablecoin backed by at least one USDC and USD reserves.

In an example embodiment, when this situation occurs, money from the USD reserves can be applied to pay the holders of the Bob coin with the fixed rate of interest. The USD reserves form part of the over-collateralization. Hence, using these reserves to pay holders of the Bob coin their interest rate payment will still maintain the Bob coin as fully collateralized.

Another technical problem is maintaining payment of a fixed rate of interest to holders of the stablecoin and a fixed rate of interest paid by borrowers of USDC as supply and demand for USDC from the lending pool varies over time. If supply and demand are not properly balanced, then it will not be possible to continue paying a consistent fixed rate of interest to holders of the stablecoin or charging a consistent fixed rate of interest to borrowers of USDC over long periods of time (e.g., over one month, six months, one year, or multiple years). These problems are exacerbated in a system that executes as a decentralized autonomous organization (DAO) since the system must autonomously determine numerous factors, such as when to increase or decrease supply in the lending pool, how to increase or decrease supply in the lending pool, how much to increase or decrease supply in the lending pool, whether to change the fixed interest rate and if so by how much, etc.

One or more example embodiments solve these technical problems.

FIG. 4 shows a method 400 to generate additional stablecoins when the stablecoins become over-collateralized in accordance with an example embodiment.

The method 400 repeats cycles of generating new or additional stablecoins to maintain a fixed rate of interest to both borrowers and Bob coin holders as supply and demand for borrowing varies over time. For example, these cycles show how the Bob protocol generates new Bob coins when existing Bob coins in circulation are sufficiently over-collateralized with USDC and USD reserves.

Each new Bob coin generated per a cycle is sold or swapped for one USDC that is added to the USDC lending pool.

According to block 410, a determination is made as to whether the Bob coins are over-collateralized. The Bob coins are over-collateralized when the number of USDC in the lending pool is greater than the number of Bob coins in circulation (e.g., the number of Bob coins minted or generated and paying interest to Bob coin holders).

If the answer to this determination is yes, then flow proceeds to block 420 which states issue new Bob coins. The system generates or mints additional Bob coins, sells or swaps each Bob coin for a USDC, and provides the USDC to the lending pool (e.g., as discussed in connection with FIG. 1).

A coin generation cycle occurs after demand for existing Bob coins outweighs supply long enough to over-collateralize the Bob coin with USDC and USD reserves. The principal idea is to generate smaller amounts of new Bob coins through repetitive cycles as opposed to launching relatively large amounts of new Bob coins in a single offering. Repetition of these cycles minimizes the financial risk to existing Bob coin holders since the market is not flooded with many new Bob coins. Issuing smaller numbers of new Bob coins further helps to ensure the lending pool of USDC is not over-supplied.

During the entire coin generation cycle, Bob coin holders continue to receive payment of a fixed interest rate, and borrowers of USDC from the lending pool continue to pay a fixed interest rate. These interest rates remain unchanged for both parties, and the Bob coins remain fully collateralized with at least one USDC throughout the coin generation cycles.

In an example embodiment, cycles of new Bob coin generation are written as conditional statements in the smart contract. The occurrence of a cycle and the number of new coins generated in the cycle depend on various factors. These factors include, but are not limited to, one or more of the following: the percentage of over-collateralization of USDC in the lending pool, the total number of Bob coins in circulation, the number of times USDC not loaned out in the lending pool are above and/or below a predetermined number, the amount of time USDC not loaned out in the lending pool are above and/or below a predetermined amount, the number of times USDC loaned out in the lending pool are above and/or below a predetermined number (e.g., USDC_{MIN}), the amount of time USDC loaned out in the lending pool are above and/or below a predetermined number, an amount of time that has elapsed since the Bob coins were issued or generated in a previous cycle, the amount of Bob coins issued or generated in a previous cycle, and other factors.

One goal of the Bob protocol is to maintain a fixed interest rate over time for both borrowers of USDC and holders of the Bob coin. Instances may occur when borrowers request more USDC than are currently available in the USDC lending pool. Unlike other liquidity lending pools, new Bob coins are not immediately generated to meet these requests. Instead, borrowers can deposit their collateral cryptocurrency, and their loan order will be filled on a first come, first serve basis when sufficient USDC in the lending pool become available. For example, a user interacts with the user interface or dashboard and enters the number of USDC desired to be borrowed and the underlying cryptocurrency being deposited as collateral. The Bob protocol executes the borrow when the USDC become available in the future.

An example embodiment of the Bob protocol differs from other decentralized exchanges that establish large liquidity pools that always have sufficient coins to loan or swap. For example, UNISWAP is an example of one such liquidity pool that utilizes an Automated Market Maker algorithm and asymptotic pricing to ensure the liquidity pool always has available assets to swap. These liquidity pools have an inherent shortcoming of price fluctuation: Users are charged different interest rates based on supply and demand. The Bob protocol avoids these price fluctuations and maintains a fixed interest rate that does not vary over time for both borrowers of USDC and Bob coin holders. For example, a first borrower borrowing USDC from the lending pool in January will pay the same fixed interest rate as a second borrower borrowing USDC from the lending pool in February - December of the same year or other months of subsequent years.

Consider the following hypothetical scenario that illustrates a potential problem of issuing new Bob coins based on real-time demand. Assume the Bob protocol has 10M Bob coins in circulation, and the USDC lending pool has a total of 10M USDC. Each coin is fully collateralized with one USDC, and all USDC are loaned to borrowers. Borrowers pay a fixed interest rate of 3% APY, and coin holders receive a fixed return of 3% APY. No problems exist in this scenario because the fixed interest rate paid by the borrowers is sufficient to cover the fixed interest paid to the coin holders.

Continuing with this scenario, the Bob protocol receives a large request to borrow 2M additional USDC. The USDC lending pool has insufficient USDC to meet this demand, so the Bob protocol generates 2M new Bob coins and sells these coins for 2M USDC to buyers who previously registered to receive new Bob coins. These newly generated 2M USDC are loaned to the borrower. Shortly thereafter, the borrower returns the 2M USDC borrowed along with the interest payment. The 2M USDC return to the lending pool. Demand for borrowing wains, and the 2M USDC sit idle in the lending pool. At this point in time, there are 12M holders of Bob coin, but only 10M USDC out on loan. The 3% APY paid by the borrowers of 10M USDC is not sufficient to pay 3% interest to the 12M holders of the Bob coin.

There are several potential solutions to the dilemma of this scenario, such as borrowing funds to secure the additional USDC, minting uncollateralized Bob coins, et al. These solutions, however, are not in the best financial interest of the holders of the Bob coin and violate one goal of the Bob protocol: Maintain a fixed interest rate for both borrowers and holders of the Bob coin while also maintaining each Bob coin fully collateralized with at least one USDC. In this way, the Bob protocol provides a secure stablecoin that pays a fixed rate of interest and a lending pool of USDC that can be borrowed at a fixed rate of interest.

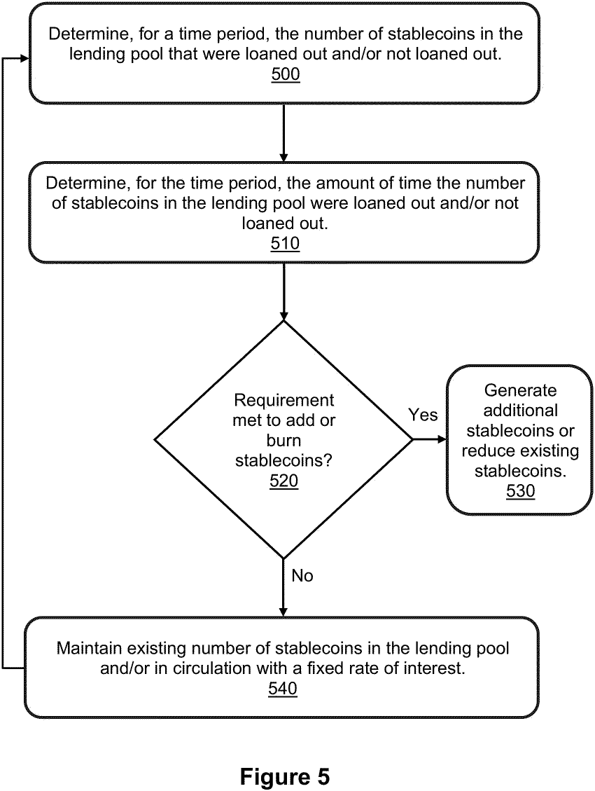

FIG. 5 is a method that determines when to generate or burn stablecoins for the lending pool in accordance with an example embodiment.

Block 500 states determine, for a time period, a number of stablecoins in the lending pool that were loaned out and/or not loaned out.

At any point in time, the protocol knows the following information: the total number of stablecoins (e.g., USDC) in the lending pool, the number of stablecoins loaned out to borrowers, the number of stablecoins available in the lending pool to be loan out (e.g., not loaned out to borrowers), the total number of stablecoins paying interest to coin holders (e.g., Bob coins paying interest to Bob coin holders), the fixed interest rate being paid to coin holders, the fixed interest rate being paid by stablecoin borrowers (e.g., borrowers of USDC from the lending pool), and other information discussed herein. These numbers can be calculated for any time period, such as during one second, one minute, one hour, one day, one week, one month, three months, one year, a lifetime of the lending pool, etc. Further, calculations for this time period can be periodic, continuous, or continual.

Block 510 states determine, for the time period, the amount of time the number of stablecoins in the lending pool were loaned out and/or not loaned out.

The protocol determines how long stablecoins in the lending pool are loaned out and not loaned out during the time period. This information can be determined and stored for each stablecoin and/or groups of stablecoins that form the lending pool.

Consider an example in which the Bob protocol analyzes data from the lending pool during each increment of time (e.g., every second, every minute, every hour, every day, every week, every month, every blockchain transaction cycle, etc.). This data includes both the number of USDC in lending pool loan out and not loaned out at any given time but also the duration of time that these stablecoins were loaned out and not loaned out.

Block 520 determines whether one or more requirements are met to generate additional stablecoins or to burn existing stablecoins.

The protocol coded into one or more smart contracts can automatically and/or autonomously add additional stablecoins to the lending pool and remove or burn stablecoins from the lending pool. Execution of adding stablecoins or removing stablecoins from the lending pool occurs when one or more predetermined conditions or requirements occur that are coded into the smart contracts.

The one or more requirements can be based on different information, factors, events, and calculations that enable the Bob protocol to automatically generate new or additional Bob coins (e.g., as discussed in FIG. 4) or burn or remove existing Bob coins from circulation. Generating additional Bob coins adds to the total number of Bob coins in circulation and hence increases the number of USDC in the lending pool. Burning or removing Bob coins reduces or lowers the total number of Bob coins in circulation and hence decreases the number of USDC in the lending pool. In order to remove Bob coins from circulation, the Bob protocol buys back Bob coins with USD reserves that form part of the over-collateralization of the Bob coin.

For example, the requirement to generate new Bob coins or reducing existing Bob coins from circulation is based on the amount of revenue generated from the loans of USDC from the lending pool versus the amount of payments of fixed interest rate made to holders of the Bob coin. If the amount of revenue generated from the loans of USDC from the lending pool is greater than the amount of payments made to holders of the Bob coin, then Bob coins are not reduced. Instead, the protocol can add new Bob coins to the number in circulation or maintain the existing number of Bob coins in circulation. By contrast, if the amount of revenue generated from the loans of USDC from the lending pool is less than the amount of payments made to holders of the Bob coin, then additional Bob coins are not generated. Instead, the protocol can burn existing Bob coins (or remove them from circulation) or maintain the existing number of Bob coins.

For example, the requirement is based on whether or not and for how long the number of USDC in the lending pool loaned out fell below or above USDC_{MIN} during a time period. For instance, the requirement is met to generate additional stablecoins if the number of USDC in the lending pool loaned out was equal to or greater than USDC_{MIN} during the time period. Alternatively, the requirement is not met to generate additional stablecoins if the number of USDC in the lending pool loaned out was less than USDC_{MIN} during the time period.

This requirement can also be based on the number of USDC in the lending pool loaned out that fell below USDC_{MIN} and what percent or ratio this number is with respect to the number of USDC not loaned out and/or the total number of USDC in the lending pool. This requirement can also be based on the amount of time that the number of USDC in the lending pool loaned out feel below USDC_{MIN} and/or the amount of time the number of USDC in the lending pool remained at or above USDC_{MIN▪}

Consider a hypothetical situation in which the total USDC in the lending pool is 10M, USDC_{MIN} is 7M, and holders of the Bob coin receive a fixed annual interest rate of 3%. If the number of USDC loaned out in the lending pool falls below 7M USDC, then the amount of income generated from interest paid by borrowers during this time is not sufficient to pay the fixed interest rate of 3% to holders of the Bob coin. During a one-year time period, the number of USDC loaned out in the lending pool stayed above 7M except for one time. During a one-hour increment of time, the number of USDC in lending pool loaned out fell to 5M. Here, USDC_{MIN} was surpassed by 2M USDC for one hour. The deficit in income or loss generated during this time period is marginal since the amount of time is small. This deficit (Loss) is approximately equal to the following:

$$\begin{matrix}\text{Loss=} \left({\text{USDC below USDC}}_{\text{MIN}}\right) \times \\ \left(\text{fixed interest rate}\right) \times \left(\text{duration of deficiency}\right) \text{.}\end{matrix}$$

For the hypothetical situation, the Loss equals the number of USDC below USDC_{MIN} (2M) x interest rate paid to holders of the Bob coin (3%) x time duration of the deficiency on yearly basis (one hour/8760 hours per year) = $6.85.

In an example embodiment, this requirement is based on one or more probabilities and/or statistics. For example, the requirement is based on a probability that the Bob protocol will generate sufficient interest income from borrowers to pay the holders of the Bob coin a fixed rate of interest. Alternatively, this requirement is based on a probability that the Bob protocol will not generate sufficient interest income from borrowers to pay the holders of the Bob coin a fixed rate of interest.

For example, the Bob protocol calculates the probability of one or more events, such as whether the fixed interest paid from borrowers of USDC is sufficient to pay holders of the Bob coin a fixed rate of interest. These events are calculated from past or historical data from the lending pool.

The Bob protocol continually tracks the number of USDC loaned out to borrowers, the number of USDC available in the lending pool to be loaned out to borrowers, the dates and times when USDC are borrowed from and returned to the lending pool, the amounts of USDC borrowed and returned by each borrower, the amount and times and dates of liquidation fees collected, an identification of each borrower, the fixed interest rate, and other information discussed herein. For example, the Bob protocol determines this information each time a block is added to the blockchain (e.g., each time a new block is added to the Ethereum blockchain if the Bob protocol is written with smart contracts executing on the Ethereum blockchain).

For example, the Bob protocol determines or calculates the frequency and duration of the following events for a time period: (1) USDC in the lending pool loaned out were less than USDC_{MIN}, (2) USDC in the lending pool loaned out were equal to USDC_{MIN}, and (3) USDC in the lending pool loaned out were greater than USDC_{MIN▪} For each of these events, the Bob protocol calculates the number of times this event occurred during the time period, the number of USDC in the lending pool and/or loaned out during the time period of this event, and the duration of the event.

The Bob protocol calculates statistical data that includes one or more of the following for the events: an average or arithmetic mean, a trimmed mean, probability distributions, variances, standard deviations, a median, a ratio, etc. These calculations can be made at a single point in time and/or over different time periods.

Consider an example in which the Bob protocol calculates probability distributions of the number of USDC in lending pool that are loaned out and not loaned for different intervals of time (e.g., each minute, each hour, each day, each week, each month, each transaction update to the blockchain, etc.). For example, the protocol plots or graphs the number of USDC in the lending pool loaned out and not loaned out during the time interval as a probability distribution. The protocol further calculates the mean or average number of USDC loaned out and/or not loaned out during this time period, skewness, median, kurtosis, mode, etc. This information also reveals the probability mass function (pmf) for each of the possible outcomes in the sample space (e.g., the probability of a given number of USDC in the lending pool not being loaned out or being loaned out and/or the probability of the number of USDC being loaned out being less than, equal to, or greater than USDC_{MIN})▪

Consider an example embodiment that calculates the probability mass function that assigns a probability (p) for the number of USDC in the lending pool loaned out (USDC_{LO}) is less than USDC_{MIN▪} For example, the Bob protocol calculates a probability function (P) as follows: P(USDC_{LO} < USDC_{MIN})▪ Example embodiments also include calculating: P(USDC_{LO} > USDC_{MIN}) and/or P(USDC_{LO} = USDC_{MIN})▪

These calculations enable the Bob protocol to know the probability that revenue generated from interest paid by borrowers will or will not be sufficient to pay a fixed rate of interest to holders of the Bob coin. These probabilities can be used to determine whether the protocol generates new Bob coins or removes existing Bob coins from circulation.

For example, if the probability of (USDC_{LO} < USDC_{MIN}) occurring is greater than a predetermined value or percentage, then the Bob protocol does not generate new Bob coins. In this situation, the Bob protocol does not generate additional Bob coins (e.g., does not initiate a new coin generation cycle). Selection of this predetermined value depends on the amount of risk the Bob protocol is coded to have. For example, the predetermined value is set to 1%, 2%, ... 5% ... 10% ... 20%, etc.

For example, if the probability of (USDC_{LO} < USDC_{MIN}) occurring is greater than a predetermined value or percentage, then the Bob protocol burns, destroys, removes, or decreases Bob coins in circulation. In this situation, the Bob protocol buys Bob coins with USD reserves and then burns of destroys these Bob coins (e.g., buys Bob coins on a decentralized exchange or DEX). Alternatively, the Bob protocol buys these Bob coins and places them in storage for future distribution. This process reduces the number of Bob coins in circulation in the market. Selection of this predetermined value depends on the amount of risk the Bob protocol is coded to have. For example, the predetermined value is set to 1%, 2%, ... 5% ... 10% ... 20%, etc.

For example, if the probability of (USDC_{LO} ≥ USDC_{MIN}) occurring is greater than a predetermined value or percentage, then the Bob protocol generates new Bob coins. In this situation, the Bob protocol generates additional Bob coins (e.g., initiates a new coin generation cycle per FIG. 4). Selection of this predetermined value depends on the amount of risk the Bob protocol is coded to have. For example, the predetermined value is set to 100%, 99%, 98%, ... 95% ... 90% ... 80%, etc.

If the answer to this determination of block 520 is “yes” then flow proceeds to block 530 that states generate additional stablecoins or reduce existing stablecoins.

When the requirements are met to generate new Bob coins, the Bob protocol generates additional or new Bob coins and then sells or swaps each of these coins for a stable form of currency, such as a single USDC, USDT, or other form of stable cryptocurrency (e.g., a government issued stablecoin).

When the requirements are met to reduce existing Bob coins, the Bob protocol uses over-collateralized income (e.g., USD reserves) to buy Bob coins from the market (e.g., a DEX) and then destroys these Bob coins. Instead of destroying these Bob coins, the protocol can place them in storage or take them out of circulation, which reduces or lowers the number of Bob coins on the market and available for purchase, swapping, trading, etc. During a subsequent coin generation cycle, the Bob protocol releases these Bob coins back into circulation. For example, the Bob protocol sells or swaps these Bob coins for USDC at a DEX and then adds these USDC to the lending pool.

The number of additional or new Bob coins generated or removed can be a fixed or predetermined amount, such as generate 1M coins during each generation or burn cycle. Alternatively, this amount can be based on the number of stablecoins (e.g., USDC) in the lending pool or Bob coins in circulation. For example, the number of Bob coins generated or burned equals a percentage of the existing stablecoins in the lending pool (e.g., 1%, 2%, 3%, 4%, 5%, 10%, or 15%). For instance, the Bob protocol increases the number of USDC in the lending pool by 5% with each coin generation cycle. As another example, the Bob protocol reduces the number of USDC in the lending pool by 5% with each coin burn cycle.

The number of Bob coins generated or reduced can vary from cycle-to-cycle and depend on statistical data or probabilities calculated from historical data. For example, as the number of additional or new Bob coins increases, the probability of (USDC_{LO} < USDC_{MIN}) also increases. For example, the number of additional or new Bob coins must meet a threshold probability that (USDC_{LO} < USDC_{MIN}) will not occur or the probability of this event occurring is low (e.g., under 10%, 5%, 4%, 3%, 2%, or 1%). For instance, generate additional or new Bob coins if the subsequent probability of event (USDC_{LO} < USDC_{MIN}) occurring is less than or equal to X%. Here, X% is selected based on the level of risk coded into the smart contracts of the Bob protocol, such as X% being 1%, 2%, 3%, 4%, 5%, ... 10%.

If the answer to this determination of block 520 is “no” then flow proceeds to block 540 that states maintain the existing number of stablecoins in the lending pool and/or in circulation with a fixed rate of interest. For example, holders of the Bob coin continue to receive a fixed rate of interest, and borrowers of USDC from the lending pool continue to pay a fixed rate of interest.

The cycle of this method repeats as flow proceeds from block 540 back to block 500.

Consider an example embodiment that executes as a DAO in which rules or methods governing the system are encoded as one or more computer programs, such as one or more smart contracts on a blockchain. For example, the DAO executes autonomously without human intervention via smart contracts on a Turing-complete platform (e.g., Ethereum). The DAO continuously tracks the revenue generated from loans of USDC from the lending pool, payments of fixed interest to holders of the Bob coin, payments of fixed interest from borrowers, and other information discussed herein. The DAO automatically executes coin generation cycles and coin burn or coin reduction cycles to maintain a supply and demand equilibrium such that the revenue generated from loans of USDC from the lending pool is equal to or greater than the fixed interest payments being made to holders of the Bob coin.

In an example embodiment, the Bob protocol is written on one or more smart contracts on a public blockchain. Further, execution and output of this code are displayed or provided to be openly transparent and easily verifiable. For example, the smart contracts are written to ensure the total number of Bob coins in circulation does not exceed the combination of USD reserves plus the USDC in the lending pool. Furthermore, part of the Bob protocol includes real-time accounting of the Bob coins in circulation, number of USDC loaned to borrowers, USDC available for loan, USD reserves, and other information. These numbers are calculated and posted at the URL of the Bob protocol.

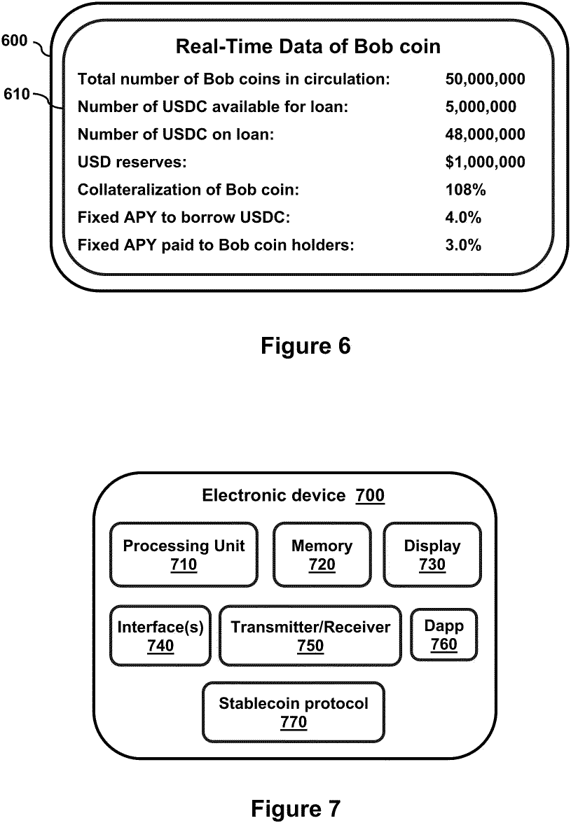

FIG. 6 shows an electronic device 600 with a display 610 that shows information posted at the URL of the Bob protocol in accordance with an example embodiment.

For example, this real-time information (shown as “Real-Time Data of Bob Coin”) includes the total number of Bob coins in circulation, the number of USDC available for loan in the lending pool, the number of USDC on loan, the USD reserves, collateralization of the Bob coin, fixed APY to borrow USDC, and fixed APY paid to Bob coin holders. For illustration, this information includes hypothetical numbers.

The Bob protocol and other contemporary decentralized cryptocurrency lenders provide financial security through over-collateralized loans. The Bob protocol, however, has an advantage over other cryptocurrency lenders: A portion of the interest paid by borrowers and liquidation fees collected from these borrowers are used to purchase USDC and USD reserves that increase the overall collateral of the Bob Coin. Overtime, the Bob coin becomes more and more over-collateralized until this over over-collateralization triggers minting or generation of new Bob coins into the market. This fact adds an extra layer of financial security not offered by the other DeFi lenders.

The following example illustrates how collateralization of the Bob coin continues to increase over time.

Assume an initial coin launch of 10M Bob coins with a set minimum purchase price or swap price of one USDC per Bob coin. Immediately after the coin launch, each Bob coin is fully collateralized with one USDC. The Bob Protocol provides these USDC into the lending pool and loans these 10M USDC to borrowers at 5% APY. Holders of the Bob coin receive 3% APY. In exchange for these loans, borrowers over-collateralize the USDC loan with a cryptocurrency that is held in a secure vault. When the borrowers repay the USDC loan, 3% goes to the holders of the Bob coin, and 2% goes to the purchase of new USDC and USD reserves. After one year, the 10M Bob coins would be over-collateralized with 10.2M USDC and USD. After five years, the 10M Bob coins would be over-collateralized with over 11 M USDC and USD. The rate of over-collateralization continues to rise with time. This rate of increase could even be greater since the Bob protocol uses any liquidation fees to purchase new USDC stablecoins or USD reserves. This over-collateralization triggers minting of new Bob coins when over-collateralization reaches a predetermined threshold.

The Bob coin and its protocol form a new generation of decentralized cryptocurrency stablecoins that provide coin holders with a fixed income in the form of a fixed interest rate payment. The Bob coin can compete with a myriad of different low-risk, fixed-interest securities offered by centralized banks around the world. The Bob coin and its protocol enable users to safely interact with a decentralized cryptocurrency stablecoin that is a trusted, safe, and effective way to store cryptocurrency assets and earn a fixed rate of return.

FIG. 7 is an electronic device 700 in accordance with an example embodiment.

The electronic device 700 includes a processor or processing unit 710, memory 720, a display 730, one or more interfaces 740, a wireless transmitter/receiver 750, a decentralized application (Dapp) 760, and stablecoin protocol 770 (such as the Bob protocol discussed herein).

Memory 720 includes computer readable medium (CRM) that stores code and/or instructions to execute one or more example embodiments. The memory also stores one or more of the blockchain, stablecoin protocol, and smart contracts.

Examples of an interface 740 include, but are not limited to, a network interface, a graphical user interface, a natural language user interface, a natural user interface, a phone control interface, a reality user interface, a kinetic user interface, a touchless user interface, an augmented reality user interface, and/or an interface that combines reality and virtuality.

The processor or processing unit 710 includes one or more of a central processing unit (CPU), digital signal processor (DSP), graphics processing unit (GPU), microprocessor, microcontrollers, field programmable gate arrays (FPGA), application-specific integrated circuits (ASIC), etc. for controlling the overall operation of memory (such as random-access memory (RAM) for temporary data storage, read only memory (ROM) for permanent data storage, and firmware). The processing unit 710 communicates with the memory and other electronic components to perform operations and tasks that implement one or more blocks of the flow diagram discussed herein. The memory, for example, stores applications, data, programs, algorithms (including software to implement or assist in implementing example embodiments) and other data.

The components shown in the electronic device 700 can exist in a single electronic device or multiple electronic devices, such as some components being in smartphone, portable electronic device, server, etc. that are distributed across the network, such as a blockchain network.

The Dapp is a computer application that executes on a blockchain network. For example, Dapps have backend code that executes on nodes of a decentralized peer-to-peer network and frontend code and user interfaces that make calls to the backend. The frontend code can execute on user devices, such as portable electronic devices (PEDs) of users. For instance, Dapps execute on and are stored on blockchain networks.

Consider an example in which the Dapp executes on nodes of the Ethereum blockchain in which the nodes execute Ethereum virtual machine (EVM) instructions that are Turing-complete. This enables Ethereum smart contracts and code to perform the functions discussed herein with regard to the Dapp and the UI on the electronic device of the user.

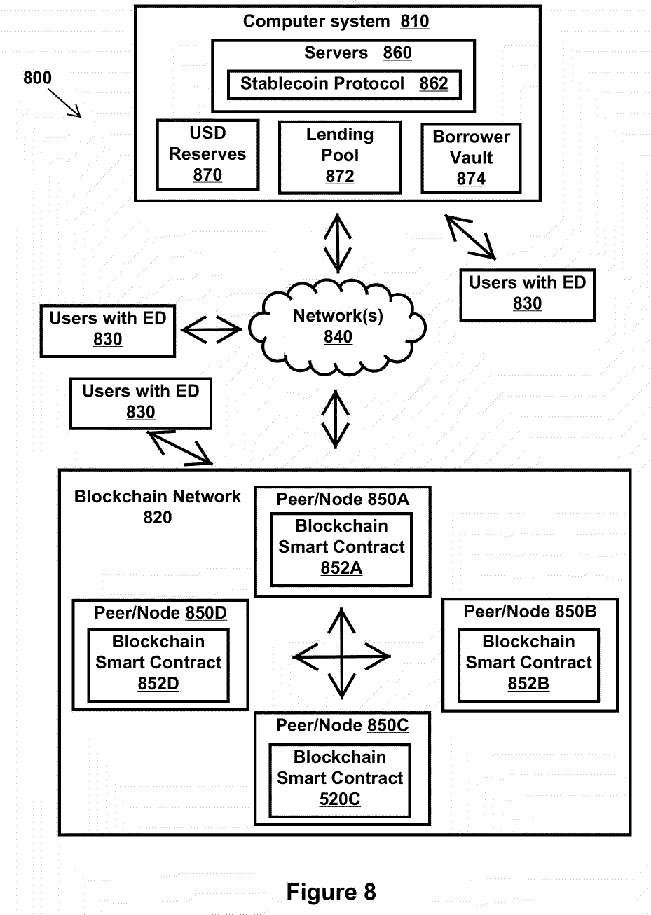

FIG. 8 is an electronic or computer system 800 in accordance with an example embodiment.

The computer system 800 includes a computer system 810, a blockchain network 820, and users with electronic devices (ED) 830 connected to or in communication with one or more networks 840.

The blockchain network 820 includes a plurality of peers, nodes, or electronic devices 850A - 850D with each peer having a blockchain and/or smart contract 852A- 852D. The blockchain network 820 can include one or more blockchain networks, such as a private blockchain network, a public blockchain network, and a consortium blockchain network.

A smart contract is a computer program that executes transactions on a blockchain. For example, the smart contract is a type of self-executing contract in which the terms and conditions of the transaction or agreement are written into lines of code. The code and accompanying agreement are decentralized and distributed in the blockchain network. By way of example, the Ethereum blockchain uses smart contracts to execute code that add data to the blockchain and perform other functions discussed herein.

A node is a computer that stores a copy of transactions to a blockchain. For example, nodes on a blockchain communicate with each other and exchange data so each node includes a full or partial copy of the transactions of the blockchain. Different types of blockchain nodes exist, such as a full node or validating node, a listening node or super node, and a miner node. A full node verifies transactions and blocks against consensus rules. Full nodes relay new transactions and blocks to the blockchain. Full nodes may have a full copy of the transaction history of the blockchain or a reduced copy of the transaction history (e.g., a light node). A listening node provides information to other nodes and functions as a redistribution point. For example, a listening node transmits blockchain history and transaction data to multiple nodes around the world. A miner node solves mathematical puzzles (proof-of-work) and add transactions to the blockchain. A miner node can also be a node that adds transactional data to the blockchain. Nodes can operate under a proof-of-work (PoW) or proof-of-stake (PoS) protocol.

The blockchain includes a growing list of records (called blocks) that are linked together using cryptography. For example, each block includes a cryptographic hash of the previous block, a timestamp, and transaction data. Examples of a blockchain include the Ethereum blockchain, the Bitcoin blockchain, and many others.

The computer system 810 includes one or more servers 860 executing the stablecoin protocol 862, such as the Bob protocol. The computer system 810 includes USD reserves 870, a lending pool 872, and a borrower vault 874.

The USD reserves include US dollars or other fiat currency or commodity, such as gold. Reserves can be stored in government institution, such as banks, private organizations, on the blockchain, or other locations. Further, the USD reserves can include other forms of currency, including a government issued stablecoin.

The lending pool 872 includes the stablecoins, such as USDC or other cryptocurrency loaned out to borrowers.

The borrower vault 874 includes memory, storage, or token vault that stores digital assets, such as digital assets, cryptocurrencies, and tokens on the blockchain or other location.

The networks 840 include one or more of the following: a cellular network, a public switch telephone network, the Internet, a local area network (LAN), a wide area network (WAN), a metropolitan area network (MAN), a personal area network (PAN), home area network (HAM), blockchain network(s), and other public and/or private networks. Additionally, the electronic devices need not communicate with each other through a network. As one example, electronic devices couple together via one or more wires, such as a direct wired-connection. As another example, electronic devices communicate directly through a wireless protocol, such as Bluetooth, near field communication (NFC), or other wireless communication protocol.

By way of example, the electronic devices of the user include, but are not limited to, handheld portable electronic devices (HPEDs), wearable electronic glasses, electronic or smart watches, wearable electronic devices (WEDs), smart earphones or hearables, electronic devices with cellular or mobile phone capabilities or subscriber identification module (SIM) cards, desktop computers, servers, portable computers (such as tablet and notebook computers), smartphones, head mounted displays (HMDs), optical head mounted displays (OHMDs), headphones, and other electronic devices with a processor or processing unit, and a memory.

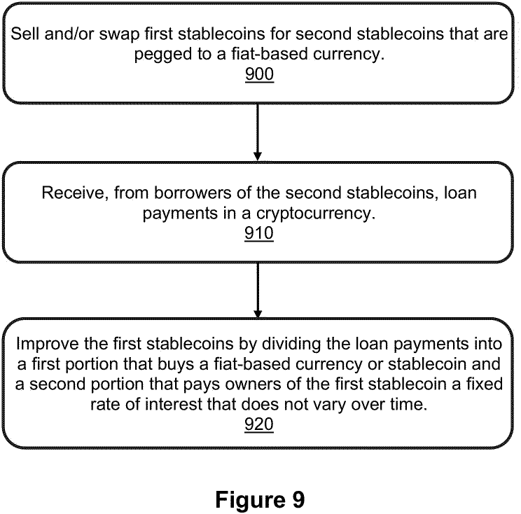

FIG. 9 is a method that provides improved stablecoins that are fully collateralized and pay a fixed rate of interest to owners of the stablecoins in accordance with an example embodiment.

Block 900 states sell and/or swap first stablecoins for second stablecoins that are pegged to a fiat-based currency.

For example, the first stablecoins are sold or swapped for one or more second stablecoins that include one or more of a fiat-backed stablecoin, a cryptocurrency-backed stablecoin, a commodity-backed stablecoin, a government-backed stablecoin, a stablecoin backed by a central bank, another stablecoin, or a fiat currency. For example, the first stablecoins are sold or swapped at a DEX or decentralized finance protocol used to exchange cryptocurrencies on a blockchain. A DEX is a cryptocurrency exchange that enables users to engage in peer-to-peer cryptocurrency transactions without the need for an intermediary. For instance, the protocol sells or swaps the first stablecoins on a cryptocurrency exchange (e.g., UniSwap, Binance, Coinbase, or PancakeSwap) for USDC or USDT.

Consider an example in which every first stablecoin is sold or swapped for one second stablecoin, and all second stablecoins are provided to a lending pool. In this instance, the number of first stablecoins equals the number of second stablecoins in the lending pool that are available to be loaned out to borrowers for a fixed rate of interest.

Block 910 states receive, from borrowers of the second stablecoins, loan payments in a cryptocurrency.

In exchange for borrowing the second stablecoin, borrowers pay an interest rate, such as fixed rate of interest. This fixed rate of interest does not vary over the term of the loan and can be, for example, a fixed APR or fixed APY.

Borrowers borrow the second stablecoin from the lending pool, such as a cryptocurrency lending pool or DeFi lending pool. Lending pools can be centralized or decentralized. For example, a decentralized lending pool enables mutually untrusted users to lend and borrow cryptocurrencies. Lending pools can be governed via smart contracts executing on a blockchain.

In an example embodiment, a one to one (1:1) ratio exists between the number of first stablecoins paying a fixed rate of interest to owners of the first stablecoin and the number of second stablecoins available for loan from the lending pool for a fixed rate of interest.

In exchange for borrowing the second stablecoin, the borrower provides collateral, such as a cryptocurrency (e.g., ETH, BTC, etc.). This collateral is held until the borrower returns the borrowed stablecoins along with payment of the fixed interest rate.

Block 920 states improve the first stablecoins by dividing the loan payments into a first portion that buys a fiat-based currency or stablecoin and a second portion that pays owners of the first stablecoin a fixed rate of interest that does not vary over time.

The loan payments received from the borrowers of the second stablecoin are divided into two portions. A first portion pays owners of the first stablecoin a fixed rate of interest. After this portion is paid or allocated, the remaining amount is paid or allocated to a second portion. The second portion buys or functions as additional collateral for the first stablecoins. For example, this second portion purchases one or more of a fiat-backed stablecoin, a cryptocurrency-backed stablecoin, a commodity-backed stablecoin, a government-backed stablecoin, a stablecoin backed by a central bank, another stablecoin, or a fiat currency.

By way of example, the second portion equals the loan payments received from the borrowers minus the fixed rate of interest paid or owed to the owners of the first stablecoin. The second portion is the amount of money or cryptocurrency left over after paying the owners of the first stablecoin.

In an example embodiment, the protocol executes to perform one or more of storing or saving the second portion, buying additional second stablecoins with the second portion and offering these additional second stablecoins for loan in the lending pool, buying back first stablecoins, or buying another stablecoin, fiat-currency, commodity, or cryptocurrency.

Consider an example in which borrowers pay the loan payment in a stablecoin, such as USDC or a government issued stablecoin. The protocol holds or stores the second portion of these stablecoins as over-collateralization for the first stablecoins.

In an example embodiment, a trigger or an event causes the protocol to purchase additional second stablecoins with the second portion once the second portion reaches a predetermined amount, such as a predetermined amount of money or value. This amount can be a fixed value, such as one hundred thousand dollars, one million dollars, or another value in another currency. Alternatively, this amount can be tied to or based on a number of second stablecoins in the lending pool. For example, the protocol is coded to purchase additional second stablecoins when the accumulative value of the second portion reaches a percentage of the value of the second stablecoins in the lending pool (e.g., 1%, 2%, 3%, 4%, 5%, ... 10%, etc.).

The protocol can purchase the additional second stablecoins on a DEX, cryptographic exchange, or market or forum where the second stablecoins are sold or swapped.

After each one of the first stablecoins are sold or swapped for at least one of the second stablecoins, the first stablecoins are fully or one hundred percent (100%) collateralized with the second stablecoins. The first stablecoins remain fully collateralized by maintaining a number of the second stablecoins provided to the lending pool equal to or greater than a number of the first stablecoins in circulation. The second portion represents an over-collateralization for the first stablecoins and also functions to provide liquidity for the owners of the first stablecoins. The second portion is held, stored, or saved and paid out at a future time when payments from the borrowers are not sufficient to pay owners of the first stablecoins a fixed rate of interest.

The protocol also determines a minimum number of the second stablecoins that need to be loaned out from the lending pool in order to generate sufficient income from the loan payments to pay the owners of the first stablecoins their fixed interest rate that does not vary over time (e.g., does not vary daily, weekly, monthly, annually, or anytime). The protocol further executes to change or alter the number of second stablecoins in the lending pool based on demand from borrowers for the second stablecoins. For instance, second stablecoins are added to or removed from the lending pool based on whether the income from the lending pool generated is sufficient to pay the owners of the first stablecoins their fixed interest rate that does not vary over time, such as daily, weekly, monthly, annually or yearly, over the life of a loan, or over the life of the stablecoin.

For example, the protocol buys additional second stablecoins in response to the loan payments received from the borrowers of the second stablecoins over a period of time being greater than the second portion paid to the owners of the first stablecoins over the period of time. As another example, the protocol reduces the second stablecoins in the lending pool that are available for loan to the borrowers in response to the loan payments received from the borrowers of the second stablecoins over a period of time being less than the second portion paid to the owners of the first stablecoins over the period of time. By way of example, the period of time can be one hour, one day, one week, one month, one year, or another period of time.

The protocol automatically adjusts or changes a number of the second stablecoins in the lending pool in order to ensure the loan payments from the borrowers of the second stablecoins are sufficient to pay owners of the first stablecoins the fixed interest rate.

Consider an example in which the first stablecoins are pegged to the second stablecoins that are USDC and/or USDT. The number of USDC and/or USDT available for loan in the lending pool is always equal to or greater than a number of the first stablecoins sold, swapped, or in circulation.

The protocol also executes to reduce the number or amount of the second stablecoins in the lending pool and/or the number or amount of first stablecoins on the market. For example, the protocol buys back or purchases first stablecoins on the market with over-collateralized funds, such as the second portion received from the borrowers. These first stablecoins were previously generated and sold or swapped by the protocol. For instance, the protocol purchases the first stablecoins from a DEX in response to the loan payments being insufficient to pay the owners of the first stablecoins the fixed rate of interest. This action reduces the total number of first stablecoins on the market or in circulation.

During periods of time when the loan payments are insufficient to pay the owners of the first stablecoin the fixed rate of interest, the protocol uses the accumulated second portion or over-collateralization to pay this difference. In this way, the owners of the first stablecoin continue to receive payment of the fixed rate of interest even though the loan payments are not sufficient.

Money or cryptocurrency generated from the loan payments are not sufficient to pay the owners of the first stablecoin when the number of second stablecoins being loaned out falls below a minimum number. As such, the protocol tracks the minimum number of second stablecoins that need to be loaned out from the lending pool in order to generate sufficient interest income to pay the owners of the first stablecoins the fixed rate of interest that does not vary.

The protocol analyzes past or historical data in order to determine a probability that the loan payments received from the borrowers will be sufficient and/or insufficient to pay the owners of the first stablecoins the fixed rate of interest. The protocol also calculates these probabilities for scenarios of adding additional first stablecoins into circulation (e.g., upon generating additional first stablecoins from a coin generation cycle).

In an example embodiment, the first stablecoin is the Bob coin, and the second stablecoin is a fiat-backed or fiat-based stablecoin, such as USDC and/or USDT.

As used herein, a “fixed rate of interest” or “fixed interest rate” is an interest rate that does not change or fluctuate during a period of time, such as during the period of time of the loan or period of time for holding the stablecoin. For example, borrowers of USDC from the lending pool pay a fixed rate of interest during the entire period of the loan of USDC (e.g., life of the loan). As another example, holders of the Bob coin receive a fixed rate of interest during the entire period of holding or owning the Bob coin or life of the Bob coin (e.g., even as the Bob coin is sold or transferred from one individual or organization to another individual or organization). Thus, the fixed rate of interest does not change regardless of changes in ownership or the money markets (e.g., DeFi cryptocurrency markets).

In some example embodiments, the methods illustrated herein and data and instructions associated therewith, are stored in respective storage devices that are implemented as computer-readable and/or machine-readable storage media, physical or tangible media, and/or non-transitory storage media. These storage media include different forms of memory including semiconductor memory devices such as DRAM, or SRAM, Erasable and Programmable Read-Only Memories (EPROMs), Electrically Erasable and Programmable Read-Only Memories (EEPROMs) and flash memories; magnetic disks such as fixed and removable disks; other magnetic media including tape; optical media such as Compact Disks (CDs) or Digital Versatile Disks (DVDs). Note that the instructions of the software discussed above can be provided on computer-readable or machine-readable storage medium, or alternatively, can be provided on multiple computer-readable or machine-readable storage media distributed in a large system having possibly plural nodes, such as nodes or computers on a blockchain. Example embodiments include code stored on one or more blockchains and/or nodes and executed as one or more smart contracts. Such computer-readable or machine-readable medium or media is (are) considered to be part of an article (or article of manufacture). An article or article of manufacture can refer to a manufactured single component or multiple components.

Blocks and/or methods discussed herein can be executed and/or made by a user, a user agent (including machine learning agents and intelligent user agents), a software application, an electronic device, a computer, firmware, hardware, a process, a computer system, one or more smart contracts, and/or an intelligent personal assistant. Furthermore, blocks and/or methods discussed herein can be executed automatically with or without instruction from a user.

1. A method that executes via smart contracts on a blockchain to provide an improved stablecoin, the method comprising:
selling, by computers executing the smart contracts on the blockchain, first stablecoins for second stablecoins pegged to a United States dollar (USD);
receiving, by the computers executing the smart contracts on the blockchain and from borrowers of the second stablecoins loaned out from a lending pool, loan payments in a cryptocurrency of a first fixed interest rate that does not vary annually; and
improving the first stablecoins by dividing, by the computers executing the smart contracts on the blockchain, the loan payments into a first portion that buys USD reserves that over-collateralize the first stablecoins and a second portion that pays owners of the first stablecoins a second fixed interest rate that does not vary annually.

2. The method of claim 1 further comprising:
buying, by the computers and with the USD reserves, additional second stablecoins in response to the loan payments received from the borrowers of the second stablecoins over a one-month period being greater than the second portion paid to the owners of the first stablecoins over the one-month period; and
adding, by the computers, the additional second stablecoins to the lending pool.

3. The method of claim 1 further comprising:
reducing, by the computers, the second stablecoins in the lending pool that are available for loan to the borrowers in response to the loan payments received from the borrowers of the second stablecoins over a one-month period being less than the second portion paid to the owners of the first stablecoins over the one-month period.

4. The method of claim 1 further comprising:
determining, by the computers, a minimum number of the second stablecoins that need to be loaned out from the lending pool in order to generate sufficient income from the loan payments to pay the owners of the first stablecoins the second fixed interest rate that does not vary annually.

5. The method of claim 1 further comprising:
adjusting, by the computers, a number of the second stablecoins in the lending pool in order to ensure the loan payments from the borrowers of the second stablecoins are sufficient to pay owners of the first stablecoins the second fixed interest rate that does not vary annually.

6. The method of claim 1 further comprising:
fully collateralizing the first stablecoins by maintaining a number of the second stablecoins provided to the lending pool equal to or greater than a number of the first stablecoins in circulation.

7. The method of claim 1, wherein each of the first stablecoins is sold for one of the second stablecoins, and a number of the second stablecoins available for loan in the lending pool is always equal to or greater than a number of the first stablecoins sold.

8. The method of claim 1, wherein each of the first stablecoins is pegged to one of the second stablecoins, and the second stablecoins are USD coins (USDC).

9. A non-transitory computer-readable storage medium storing code that one or more electronic devices execute via smart contracts on a blockchain as a method that provides stablecoins that pay a fixed rate of interest, the method comprising:
fully collateralizing the stablecoins on theblockchain to fiat-based stablecoins by pegging each one of the stablecoins to one of the fiat-based stablecoins;
receiving, from borrowers of the fiat-based stablecoins, loan payments; and
dividing, by the smart contracts executing on the blockchain, the loan payments into a first portion that buys United States dollar (USD) reserves that over-collateralize the stablecoins and a second portion that pays owners of the stablecoins a fixed rate of interest that does not vary.

10. The non-transitory computer-readable storage medium storing the code of claim 9 in which the method further comprises:
loaning the fiat-based stablecoins from a lending pool; and
purchasing, with the USD reserves, additional fiat-based stablecoins that are added to a lending pool in response to an amount of the USD reserves increasing to a predetermined amount.

11. The non-transitory computer-readable storage medium storing the code of claim 9 in which the method further comprises:
purchasing, with the USD reserves, the stablecoins from a decentralized exchange (DEX); and
burning the stablecoins purchased from the DEX in response to the loan payments being insufficient to pay the owners of the stablecoins the fixed rate of interest that does not vary.

12. The non-transitory computer-readable storage medium storing the code of claim 9 in which the method further comprises:
determining when the loan payments are not sufficient to pay the owners of the stablecoins the fixed rate of interest that does not vary; and
paying the owners of the stablecoins the fixed rate of interest from the USD reserves in response to determining that the loan payments are not sufficient to pay the owners of the stablecoins the fixed rate of interest that does not vary.

13. The non-transitory computer-readable storage medium storing the code of claim 9 in which the method further comprises:
tracking a minimum number of the fiat-based stablecoins that need to be loaned out from a lending pool in order to generate sufficient interest income to pay the owners of the stablecoins the fixed rate of interest that does not vary.

14. The non-transitory computer-readable storage medium storing the code of claim 9 in which the method further comprises:
maintaining a number of the stablecoins in circulation always equal to a number of the fiat-based stablecoins available for loan from a lending pool.

15. The non-transitory computer-readable storage medium storing the code of claim 9 in which the method further comprises:
determining a probability that the loan payments received from the borrowers will be sufficient to pay the owners of the stablecoins the fixed rate of interest after additional stablecoins are added to circulation; and
generating the additional stablecoins in response to determining the probability that the loan payments received from the borrowers will be sufficient to pay the owners of the stablecoins the fixed rate of interest.

16. A method that provides improved stablecoins, the method comprising:
collateralizing the stablecoins on a blockchain to fiat-based stablecoins by selling or swapping, by computers executing smart contracts on the blockchain, each one of the stablecoins for a single one of the fiat-based stablecoins;
receiving, by computers executing the smart contracts on the blockchain and from borrowers of the fiat-based stablecoins, loan payments; and
dividing, by the computers executing the smart contracts on the blockchain , the loan payments into a first portion that buys fiat currency that over-collateralizes the stablecoins and a second portion that pays owners of the stablecoins a fixed rate of interest that does not vary over time.

17. The method of claim 16, wherein the method executes as a decentralized autonomous organization (DAO) without human intervention.

18. The method of claim 16 further comprising:
adding and removing a number of the fiat-based stablecoins in a lending pool such that the loan payments from the borrowers is greater than or equal to the fixed rate of interest paid to the owners of the stablecoins, wherein the fixed rate of interest is an annual percentage yield (APY) that does not vary over time.

19. The method of claim 16 further comprising:
adding and removing a number of the fiat-based stablecoins in a lending pool in order to maintain both a fixed rate of interest paid by the borrowers that does not vary over time and the fixed rate of interest paid to the owners of the stablecoins.

20. The method of claim 16, wherein the fiat-based stablecoins are pegged to a United States dollar, and a number of the stablecoins in circulation always equals a number of the fiat-based stablecoins available for loan to the borrowers from a lending pool.
